(19) United States
(12) Patent Application Publication
(10) Pub. No.: US 2025/0272772 A1
(43) Pub. Date: Aug. 28, 2025

(54) PREFERENCE DIFFERENTIAL MENU (PDM) GENERATOR AND PREPARATION TOOL

(71) Applicant: Eyal Levy, Nashua, NH (US)

(72) Inventor: Eyal Levy, Nashua, NH (US)

(21) Appl. No.: 19/061,969

(22) Filed: Feb. 24, 2025

Related U.S. Application Data
(60) Provisional application No. 63/556,857, filed on Feb. 22, 2024.

(51) Int. Cl. G06Q 50/12; G06F 9/451; G06Q 30/0203

(52) U.S. Cl. CPC G06Q 50/12; G06F 9/451; G06Q 30/0203

(57) ABSTRACT

The present invention is directed to methods and tools that offer a person the ability to aggregate the allergies and dietary restrictions, as well as the predilections and disinclinations in generating a menu for multiple people invited to a meal, or an event where food would be served. Moreover, the present invention is further directed to spaces or locations capable of hosting such methods and tools, equipped with the appropriate equipment and accessories.

### RELATED APPLICATIONS

This application is related to U.S. Provisional Patent Application No. 63/556,857, filed on Feb. 22, 2024, the entirety of which is incorporated herein by reference.

### BACKGROUND OF THE INVENTION

Many people who have a desire to host guests for a meal, or other event where food is served, are generally concerned about creating good experiences for their guests. Choosing the right venue, and the right meal introduce additional major difficulties. Moreover, in this world of personal touches, people have been turning to host where they feel they can offer the most personal touches; this often being the host's home. However, food restrictions based on allergies or dietary restrictions have become an increasing concern in today's food-conscious society, which therefore increases the responsibilities of the host.

This increased responsibility is quite challenging, and typically weighs against a person's desire to host. Furthermore, the complication of determining and balancing the restrictions and dietary considerations for more than one guest, makes meal planning for a group of people nearly impossible to accomplish successfully. Beyond food allergies and restrictions, people may refrain from hosting because they are challenged with cooking, believing that it is too difficult or they are not able to cook the right amount of food (e.g., in many cases, too much). Further, as an additional frustration, people that desire to host an event, do not always like to host at their homes. Especially in big cities, where people do not always have the space to host guests.

Although there are tools known to create personal profiles accommodating allergies or dietary restrictions related to menu creation or restaurant selection, these tools have failed to offer a host the ability to construct meals that account for the allergies or dietary restrictions of more than one person. What is more, these existing tools only address subtraction analysis for an individual, and cannot account for food preferences, i.e., predilections (likes) and dislikes/disinclinations, in the creation of a meal for multiple people.

As such, there remains a need for methods and tools that offer a person the ability to accommodate the allergies and dietary restrictions, as well as the predilections and disinclinations in generating a menu for multiple people invited to a meal, or an event where food would be served. There also remains a need for spaces or locations that could host such methods and tools, equipped with the appropriate equipment and accessories.

### SUMMARY OF THE INVENTION

Accordingly, the present invention is directed to methods and tools that offer a person the ability to aggregate the allergies and dietary restrictions, as well as the predilections and disinclinations in generating a menu for multiple people invited to a meal, or an event where food would be served. Moreover, the present invention is further directed to spaces or locations capable of hosting such methods and tools, equipped with the appropriate equipment and accessories.

One aspect of the present invention provides a preference differential menu (PDM) generator and preparation tool comprising a user interface for collecting and aggregating data, wherein the user interface comprises a first machine-readable medium having instructions stored thereon for execution by a processor to perform a method comprising the steps of: accessing the user interface by a host user (e.g., secure access); collection and storage of host preference data on a second machine-readable medium; collection and storage of a guest preference data on a third machine-readable medium; aggregation of the stored host preference data and the stored guest preference data using preference differential analytics; and definition of a dish matrix array based on said aggregation from which a preference differential menu (PDM) is generated, such that the PDM is generated and is a tool for use by the user in preparing the PDM.

Another aspect of the present invention provides a building for preparing a preference differential menu (PDM) structured to comprise: a preference differential menu (PDM) generator and preparation tool of the present invention such that a PDM is generated and is a tool for use by the user in preparing the PDM; an ingredient collection for use in preparing the PDM; and one or more devices for preparing the PDM.

Another aspect of the present invention provides a method for preparation by a host user of a preference differential menu (PDM) for a guest user comprising the steps of: offering access to a building for preparing a preference differential menu (PDM) structured to comprise: a preference differential menu (PDM) generator and preparation tool of the present invention such that a PDM is generated and is a tool for use by the user in preparing the PDM, an ingredient collection for use in preparing the PDM, and one or more devices for preparing the PDM (e.g., stove/oven, refrigerator, knives, pots/pans, dishes, or utensils); offering access to the preference differential menu (PDM) generator and preparation tool; offering access to the an ingredient collection for use in preparing the PDM; and offering access to one or more devices for preparing the PDM,

such that the host user may generate the PDM and prepare the PDM within the building for the guest users.

### BRIEF DESCRIPTION OF THE FIGURES

Advantages of the present methods, tools, and related structures (e.g., buildings) will be apparent from the following detailed description, which description should be considered in combination with the accompanying figures, which are not intended to limit the scope of the invention in any way.

FIG. 1 depicts a flow diagram of an exemplary embodiment of the preference differential menu (PDM) generator and preparation tool of the present invention.

FIG. 2 depicts the flow of information that may modify the elected preference differential menu (PDM) of FIG. 1, through contributory factors to generate a preparation output.

FIG. 3 depicts an exemplification of certain building of the present invention that incorporate a preference differential menu (PDM) generator and preparation tool of the present invention.

### DETAILED DESCRIPTION OF THE INVENTION

The methods of the present invention serve as the basis for tools and buildings suitable for hosting such tools, and are capable of creating improved experiences for the guests of a hosted meal, or other event where food is served. The methods, tools, and buildings account for not only food restrictions based on allergies or dietary restrictions, but also food preferences. Furthermore, the presently described methods and tools serve to uniquely aggregate these allergies and restrictions with these food preferences of the host and one or more guests.

The methods and tools described herein provide a dish matrix array based on this aggregation that represents suitable alternatives, for example, optimized for amount or ingredient. The host selects among the alternatives and utilizes cooking content presented by the methods and tools of the present invention, depicting recipes (e.g., in a user-friendly way), and calculating the right quantities based on the number of guests. In certain embodiments, this innovative technology will pair with a physical experience, a building or structure designed as a comprehensive environment equipped with kitchen facilities, stocked ingredients, and dedicated entertainment spaces for eating. The spaces, which include tools of the present invention, will be suitable for users to host meals (and events), enjoying the joy of food and entertaining in a more inclusive environment to match their needs.

As such, the present invention is directed to methods and tools that offer a person the ability to aggregate the allergies and dietary restrictions, as well as the predilections and disinclinations in generating a menu for multiple people invited to a meal, or an event where food would be served. Moreover, the present invention is further directed to spaces or locations capable of hosting such methods and tools, equipped with the appropriate equipment and accessories.

The present invention, including methods, tools, and related buildings/structures for implementing these methods and tools will be described with reference to the following definitions that, for convenience, are set forth below. Unless otherwise specified, the below terms used herein are defined as follows:

### =Definitions

As used herein, the term “a,” “an,” “the” and similar terms used in the context of the present invention (especially in the context of the claims) are to be construed to cover both the singular and plural unless otherwise indicated herein or clearly contradicted by the context.

The language “and/or” is used herein to mean both “and” in the conjunctive form and “or” in the disjunctive form.

As used herein, the language “application programming interface” or “API” are art-recognized, and used interchangeably, to describe a type of software interface, offering a service to other pieces of software, i.e., a way for two or more computer programs to communicate with each other. In contrast to a user interface, which connects a computer to a person, an application programming interface connects computers or pieces of software to each other. It is not intended to be used directly by a person (the end user) other than a computer programmer who is incorporating it into the software. An API is often made up of different parts which act as tools or services that are available to the programmer. A program or a programmer that uses one of these parts is said to call that portion of the API. The calls that make up the API are also known as subroutines, methods, requests, or endpoints. An API specification defines these calls, meaning that it explains how to use or implement them.

The term “building” as used herein, describes a structure with a roof and wall(s) that enclose a defined space.

The term “definition” is used herein to describe the act of defining, e.g., the definition of a dish matrix array is the act of defining a dish matrix array.

The language “ingredient collection” is used herein to describe the collection/gathering of ingredients assembled for use in preparing a menu, e.g., a PDM generated by the methods of the present invention.

The term “interfacing” is art-recognized, and is used herein to describe the means of communication between two entities, for example a system/tool and user data entry. In certain embodiments, the interfacing may be bi-directional. In other embodiments, the interfacing may be uni-directional. In particular embodiments, such interfacing may be achieved through a graphical user interface.

The language “machine-readable medium” is art-recognized, and describes a medium capable of storing data in a format readable by a mechanical device (rather than by a human). Examples of machine-readable media include magnetic media such as magnetic disks, cards, tapes, and drums, punched cards and paper tapes, optical disks, barcodes, magnetic ink characters, and solid state devices such as flash-based, SSD, etc. Machine-readable medium of the present invention are non-transitory, and therefore do not include signals per se, i.e., are directed only to hardware storage medium. Common machine-readable technologies include magnetic recording, processing waveforms, and barcodes. In particular embodiments, the machine-readable device is a solid state device. Optical character recognition (OCR) can be used to enable machines to read information available to humans. Any information retrievable by any form of energy can be machine-readable. Moreover, any data stored on a machine-readable medium may be transferred by streaming over a network. In a particular embodiment, the machine readable medium is a network server disk, e.g., an internet server disk, e.g., a disk array. In specific embodiments, the machine-readable medium is more than one network.

The language “offering access” is used herein to describe providing the availability of a resource to a user, e.g., providing the availability of a building or an ingredient collection.

The language “preference data” involves a data capture of a user's (e.g., host or guest) information on dietary and allergen restrictions, food dislikes/disinclinations, as well as food predilections/likes. Such preference data is distinct from simple subtraction data analysis that are used for dietary and allergen restrictions alone. In particular, the preference data of the present invention integrates and aggregates more than just the subtracted dietary and allergen restrictions, but also requires aggregating food dislikes/disinclinations, as well as food predilections/likes along with these subtractions.

The language “preference differential menu” is used herein to described a menu selected from a dish matrix array of the present invention assembled using the preference differential analytic method described herein.

The language “preparation output” is used herein to describe the items that of produced for use in preparing the PDM of the present invention, i.e., once a PDM is generated. In certain embodiments, the preparation output is selected from one or more of the group consisting of recipes, shopping lists, shopping amounts, kitchen accessories required (e.g., pots/pans/cookware/utensils/devices) and preparation instructions. In particular embodiments, a written menu may be assembled and provided to guest users. In certain embodiments, the host user receives access to video content that assists in meal preparation.

The term “structured” as used in herein in the language “structured to comprise” is used to describe the buildings of the present invention constructed, arranged, or organized to comprise certain identified components.

The term “user” is used herein to describe any person that interfaces with the tools of the present invention described herein through electronic means, e.g., computer or mobile device. Such user may be credentialed or non-credentialed, and which may afford certain access rights in the interface based on such status. In certain embodiments, the user is a host user. In certain alternative embodiments, the user is a guest user.

The language “user interface” is used herein to describe the graphical user interface (GUI), e.g., which allows a user to interface with the application programming interface (API), and enter data using interface components such as buttons, text fields, check boxes, etc.

### II. Methods of the Invention

The present invention provides methods of generating a preference differential menu (PDM). As such, one embodiment of the present invention is a method comprising the steps of:
accessing a user interface by a host user (e.g., secure access);
collection and storage of host preference data on a machine-readable medium;
collection and storage of a guest preference data on a second machine-readable medium;
aggregation of the stored host preference data and the stored guest preference data using preference differential analytics; and
definition of a dish matrix array based on said aggregation from which a preference differential menu (PDM) is generated, such that the PDM is generated for use (e.g., a tool) by the user in preparing the PDM.

In certain embodiments of the present invention, the method further comprises the step of: election of a unique dish matrix by host user from the dish matrix array, such that the preference differential menu (PDM) is generated.

In certain embodiments of the present invention, the method further comprises the step of: quantification of ingredients of the elected unique dish matrix. In certain embodiments, the quantification of ingredients is optimized, e.g., based on guest users per dish or dishes and servings per user.

In certain embodiments of the present invention, the method further comprises the step of: applying a scaling factor based on increases in guest user count.

In certain embodiments of the present invention, the method further comprises the step of: generating a preparation output. In certain embodiments, the preparation output is selected from one or more of the group consisting of recipes, shopping lists, shopping amounts, kitchen accessories required (e.g., pots/pans/cookware/utensils/devices) and preparation instructions. In particular embodiments, a written menu may be assembled and provided to guest users.

### A. Accessing User Interface By Host User

The methods of generating a preference differential menu (PDM) of the present invention comprise the step of accessing a user interface by a host user. In certain embodiments, the access to the user interface is secure access, i.e., requiring secure access via well-known security techniques, including passwords, encryption, and/or authentication. In particular embodiments, access to the interface is based on subscription access, i.e., payment of a subscription fee.

In certain embodiments of the present invention, the host user creates an event. In certain embodiments, the host selects the time of the event. In certain embodiments, the host invites one or more guest users, e.g., from a contact list.

In certain embodiments of the present invention, the host user accesses the user interface on a mobile device (e.g., cellular phone or tablet). In certain embodiments, the user interface is accessed through an application. In certain embodiments, the user interface is accessed through a website.

In certain embodiments of the present invention, the host user accesses the user interface on a computer. In certain embodiments, the user interface is accessed through an application. In certain embodiments, the user interface is accessed through a website.

### B. Collection And Storage Of Host Preference Data

The methods of generating a preference differential menu (PDM) of the present invention comprise the step of collection and storage of host preference data on a machine-readable medium. In this step, the data may be gathered from the host in any manner desired suitable to obtain the desired information on preferences. Once collected, the host user preference data is stored on a first machine-readable medium

The host user preference data is collected through the user interface. In particular embodiments, the host user preference data may include host user dietary restrictions, host user allergies, host user food predilections, host user food dislikes, total guest users, number of dishes, type of dishes and food category (ies). In certain embodiments, the host user preference data collected may be selected from the group consisting of meal type, cuisine type, dietary restrictions, allergens, avoided foods (i.e., foods disliked, for example cilantro), spice level, cooking/baking skill level, and any combination thereof.

In certain embodiments of the present invention, additional information relating to more general user profile may be also be collected. In certain embodiments, the host user profile may select the skill level (i.e., difficulty of preparation) of the preference differential menu (PDM). In certain embodiments, the host user profile may select the amount of preparation time for the preference differential menu (PDM).

In certain embodiments of the present invention, the host user may have a saved profile already containing preference data that may be used in replacement or supplement to the user preference data collected for a specific event.

In certain embodiments of the present invention, the collection of host preference data comprises administration of a first survey, e.g., requesting information on dietary and allergen restrictions, food dislikes, and food likes.

In certain embodiments, the host chooses how many dishes, e.g., from a list of dish numbers. In certain embodiments, this selection is made as part of the first survey.

In certain embodiments, the host chooses the type of dishes, e.g., plated or family style. In certain embodiments, this selection is made as part of the first survey.

In certain embodiments, the host chooses the food category (ies) of the dishes, e.g., from a list of dish numbers. In certain embodiments, this selection is made as part of the first survey. In particular embodiments, the food category is selected from the group consisting of Japanese, Mexican, Mediterranean, Asian (general), American, Korean, Italian, Indian, World's Kitchen (e.g., dishes from other places), and any combination thereof. In particular embodiments, the host is able to select food categories from a list of popular selections. In particular embodiments, the host is able to select food categories from a list of prior selections, e.g., listed as favorites. In certain embodiments of the present invention, the first machine-readable medium is selected from the group consisting of magnetic media, punched cards, paper tapes, optical disks, barcodes, magnetic ink characters, and solid state devices. In certain embodiments, the machine-readable medium is one or more network server disks.

### C. Collection And Storage Of Guest Preference Data

The methods of generating a preference differential menu (PDM) of the present invention comprise the step of collection and storage of a guest preference data on a second machine-readable medium. In certain embodiments, the guest preference data of more than one guest is collected. In this step, the data may be gathered from the guest user in any manner desired suitable to obtain the desired information on preferences. Once collected, each guest user preference data is stored on a second machine-readable medium.

The guest user preference data is collected through the user interface. In particular embodiments, the guest user preference data may include guest user dietary restrictions, guest user allergies, guest user food predilections, guest user food dislikes, and food category (ies) preferences. In certain embodiments, the guest user preference data collected may be selected from the group consisting of meal type, cuisine type, dietary restrictions, allergens, avoided foods (i.e., foods disliked, for example cilantro), spice level, and any combination thereof.

In certain embodiments of the present invention, additional information relating to more general user profile may be also be collected.

In certain embodiments of the present invention, the guest user may have a saved profile already containing preference data that may be used in replacement or supplement to the user preference data collected for a specific event.

In certain embodiments of the present invention, the collection of guest preference data comprises administration of a second survey, e.g., requesting information on dietary and allergen restrictions, food dislikes, and food likes.

In certain embodiments of the present invention, the first survey is the same as the second survey.

In certain embodiments of the present invention, the first machine-readable medium and the second machine-readable medium are the same.

In certain embodiments of the present invention, each guest's preferences can be represented as a vector, Gi:

Gi=(M,C,S,P),

where:
M is the meal type preference.
C is the cuisine preference.
S is the skill level.
P is the spice level.

### D. Aggregation Of Stored Host Preference Data And Stored Guest Preference Data

The methods of generating a preference differential menu (PDM) of the present invention comprise the step of aggregation of the stored host preference data and the stored guest preference data using preference differential analytics. The preference differential analytics of the present invention utilize the stored preference data from the host user and each of the guest users assigning differential analytical weight to the components of the preference data. The preference differential analytic processing interprets the dietary restrictions, allergies, predilections and disinclinations across the host user and each of the guest users, matching the preference data against potential dishes to aggregates the preference data into a defined dish matrix array based on the aggregation.

In certain embodiments of the present invention, utilizing the stored preference data from the host user and each of the guest users, the preference differential analytic starts with all of the available recipes, filters by desired (and weighted) cuisine and then desired (and weighted) meal type. The intersection of these filters is then subsequently filtered using the dietary restrictions, allergies, food predilections and food disinclinations, modified through consideration of recipes with available substitutions.

In certain embodiments of the present invention, the aggregation of the stored host preference data and the stored guest preference data using preference differential analytics produces the final set of recipes, ultimately offered as a dish matrix array (F), and, for example, can be represented as:

F=(R∩C)/M)∩(D∩S)∩A)

### Breaking it Down:

Initial Filter: (R N C) N M
   Start with all recipes R.
   Filter by cuisine preference data, resulting in set C.
   Filter by meal type preference data, resulting in set M.
   The intersection of these sets gives us recipes that match both cuisine preference data and meal type preference data criteria.
Dietary and Allergen Filters: D U S and A
   D is the set of recipes that match the user's diet preference data (e.g., dietary restrictions, food predilections, and food disinclinations).
   A is the set of recipes that are safe considering the user's allergen sensitivities preference data.
   S represents recipes that have suitable substitutions. It accounts for both diet preference data and allergen preferences.
   The union of D and S provides all recipes that are either already suitable or can be made suitable through substitutions.
   This set is then intersected with A to ensure allergen safety.

This results in Final Set: F. Using this aggregated data set, the dish matrix array can be generated according to the number of guest users (diners).

In certain embodiments of the present invention, the recipe database is stored on a machine-readable medium. In certain embodiments, the recipe database comprises recipes normalized to a designated serving size. In particular embodiments, the recipes are tested and calculated to serve 4 guest users (diners) and to result in a balanced meal taking into account less excess and food waste. In particular embodiments, when scaling these recipes, the ingredients amount will increase or decrease according to the number of diners based on the 4 servings per recipe.

In certain embodiments of the present invention, the recipe database is not stored on a machine-readable medium, e.g., being derived from the use of an API. In certain embodiments, the recipes are processed through an API that normalizes the recipe to a designated serving size.

In certain embodiments of the present invention, the aggregation of the stored host preference data and the stored guest preference data requires a minimum number of guest preference data, e.g., received by a response date set by the host. In certain embodiments, the response by the minimum number of guest users triggers the aggregation.

### E. Definition Of Dish Matrix Array Based On Aggregation

The methods of generating a preference differential menu (PDM) of the present invention comprise the step of definition of a dish matrix array based on said aggregation from which a preference differential menu (PDM) is generated, such that the PDM is generated for use (e.g., a tool) by the user in preparing the PDM. The dish matrix array comprises an array/list of suitable alternatives for selection by the host user, which when prepared together, serve as a meal for the host user and guest users, e.g., based on a pre-designated serving size per user. In particular embodiments, these dish matrices group multiple dishes together that form a meal, and have multiple options of these groupings that form the array. The dish matrix array is defined by which dishes are suitable for which users, based on the users' preference data. The preference differential menu (PDM) is defined (and generated) once the host makes a final election of dishes from the dish matrix array, which is ultimately derived from the preference differential analysis.

In certain embodiments of the present invention, the definition of the dish matrix array comprises the step of identifying dish types (e.g., appetizer, main course, side dish, and salad). In certain embodiments, the PDM generator and preparation tool categorizes recipes into four types: appetizer, main course, side dish, and salad. In certain embodiments of the present invention, the definition of the dish matrix array comprises the step of determining the number of dishes. In certain embodiments, if the number of guest users is 4 or less, only one dish is selected for each category: appetizer, main course, side dish, and salad. In certain alternative embodiments, for more than 4 guest users, two dishes are selected for appetizers and main courses, and one dish each for side dishes and salads.

In certain embodiments of the present invention, the definition of the dish matrix array comprises the step of determining the number of dishes using the following formulae:
For ≤4 guest users: 1 dish per category.
For >4 guest users: 2 dishes for appetizers and main courses, 1 for others.

In certain embodiments, once the number of dishes is established, recipe selection in the dish matrix array filters recipes by cuisines, meal types, and skill level. In particular embodiments, a number of dishes of each dish matrix may be comprise extra dishes as options or optional. In certain embodiments, each of the recipe's time is converted into a standardized unit, e.g., minutes, and compared to any requested time preference In certain embodiments of the present invention, the dish matrix array offers a variety of types of cuisine.

In certain embodiments of the present invention, the dish matrix array offers a variety of substitutions for ingredients. In certain embodiments, the host user may alter or add, e.g., review or edit a dish offered in the dish matrix array. In particular embodiments, the method of generating a preference differential menu (PDM) of the present invention further comprises the step of reviewing and/or commenting on the alteration or addition.

In certain embodiments of the present invention, the host user may request a specific dish be included in the dish matrix array. In certain embodiments, the method of generating a preference differential menu (PDM) of the present invention further comprises the step of reviewing and/or commenting on the dish inclusion.

In certain embodiments of the present invention, the host user may request a specific dish be included in the PDM. In certain embodiments, the method of generating a preference differential menu (PDM) of the present invention further comprises the step of reviewing and/or commenting on the dish inclusion in the PDM.

In certain embodiments of the present invention, the dish matrix array rules may require if a main course is carb focused, it will be accompanied by a veggie/vegetable side dish.

In certain embodiments of the present invention, the dish matrix array rules may require if a main course is protein focused, it will be accompanied by a carb/veggie side dish.

In certain embodiments of the present invention, the dish matrix array rules may require if a main course is veggie focused, it will be accompanied by a carb side dish.

In certain embodiments of the present invention, the defined dish matrix array is comprised of a variety of potential personalized meal plans for each user, i.e., broken down by each user. In certain embodiments, the dish matrix array presents available dishes per user based on the user's preference data, ensuring each user is only served what they can and desire to eat. In particular embodiments, the defined dish matrix array logs the outputs, such as total guest users per dish and filtered dishes and servings per user.

### F. Election, Quantification, Scaling, and Output

In certain embodiments of the present invention, the method further comprises the step of: election of a unique dish matrix by host user from the dish matrix array, such that the preference differential menu (PDM) is generated.

In certain embodiments of the present invention, the method further comprises the step of: quantification of ingredients of the elected unique dish matrix, e.g., accounting for the number of guest users and their meal preferences. In certain embodiments, the quantification of ingredients is optimized, e.g., based on guest users per dish or dishes and servings per user.

In certain embodiments of the present invention, the method further comprises the step of: applying a scaling factor based on increases in guest user count. The scaling factor is used to adjust the ingredient quantities of each recipe. In particular, the scaling factor is how much to multiply the ingredients of the base recipe by to cater to the specified number of guest users. In certain embodiments, for appetizers and main courses, the factor is based on a total of 8 servings across two dishes, while for side dishes and salads/sides, it is based on the standard 4 servings per dish.

In certain embodiments of the present invention, the scaling of recipes may be represented as a formula defined as follows:
For Appetizers and Main Courses:
   Total Base Servings=8 (since each dish type includes 2 dishes, each serving 4 guest users)
   Scaling Factor=Total Guest Users/Total Base Servings
For Side Dishes and Salad/Side Dishes:
   Base Servings=4 (each dish type includes 1 dish serving 4 guest users)
   Scaling Factor=Total Guest Users/Base Servings

$$\cdot Appetizer / Main Course Scaling Factor :$$

$${Factor}_{appetizer / main course} = \frac{Total Guests}{8}$$

$$\cdot Side Dish / Salad / Side Scaling Factor :$$

$${Factor}_{side d ish / salad / s ide} = \frac{Total Guests}{4}$$

In certain embodiments of the present invention, the method further comprises the step of: generating a preparation output, e.g., once a PDM is generated. In certain embodiments, the preparation output is selected from one or more of the group consisting of recipes, shopping lists, shopping amounts, kitchen accessories required (e.g., pots/pans/cookware/utensils/devices) and preparation instructions. In particular embodiments, a written menu may be assembled and provided to guest users. In certain embodiments, the host user receives access to video content that assists in meal preparation.

### III. Tools of the Invention

The methods of the present invention may be utilized and implemented as a preference differential menu (PDM) generator and preparation tool. As such, another embodiment of the present invention provides a preference differential menu (PDM) generator and preparation tool comprising a user interface for collecting and aggregating data, wherein the user interface comprises a first machine-readable medium having instructions stored thereon for execution by a processor to perform a method comprising the steps of:
accessing the user interface by a host user (e.g., secure access);
collection and storage of host preference data on a second machine-readable medium;
collection and storage of a guest preference data on a third machine-readable medium;
aggregation of the stored host preference data and the stored guest preference data using preference differential analytics; and
definition of a dish matrix array based on said aggregation from which a preference differential menu (PDM) is generated, such that the PDM is generated for use (e.g., a tool) by the user in preparing the PDM.

In certain embodiments of the present invention, the first machine readable medium, the second machine readable medium, and/or the third machine readable medium are the same.

In certain embodiments of the present invention, the method further comprises the step of communication between users, e.g., host and guest through the user interface.

In certain embodiments of the present invention, the method further comprises the step of sending each user a notification, e.g., direct message or email, e.g., to rate the experience. In certain embodiments, each guest user receives a notification inquiring about one or more of the following:
How did the user like each dish, e.g., rating from 1-5.

In certain embodiments, each host user receives a notification inquiring about one or more of the following:
How did the user like each dish, e.g., rating from 1-5;
How easy was the process/menu/preparation, e.g., rating from 1-5;
Overall rating for the bash, e.g., rating from 1-5;
Offering ability to upload pictures from the meal; and
Offering ability to share on social media photos from the meal.

In certain embodiments of the present invention, the tool utilizes feedback in machine learning to improve definition of the dish matrix array suggestions/aggregation. In certain embodiments of the present invention, the recipe database is stored on a fourth machine-readable medium. In certain embodiments, the recipe database comprises recipes normalized to a designated serving size. In particular embodiments, the first machine readable medium, the second machine readable medium, the third machine readable medium, and/or the fourth machine-readable medium are the same

In certain embodiments of the present invention, the recipe database is not stored on a machine-readable medium, e.g., being derived from the use of an API. In certain embodiments, the recipes are processed through an API that normalizes the recipe to a designated serving size.

### IV. Building Structures of the Invention

The methods and tools of the present invention may serve as components of and be implemented in a building, providing a unique space for employing the methods and tools of the present invention. As such, another embodiment of the present invention provides a building for preparing a preference differential menu (PDM) structured to comprise:

a preference differential menu (PDM) generator and preparation tool of the present invention such that a PDM is generated for use (e.g., a tool) by the user in preparing the PDM;
an ingredient collection for use in preparing the PDM; and
one or more devices for preparing the PDM.

In certain embodiments of the buildings of the present invention, the ingredient collection includes any ingredient required to prepare the PDM. In certain embodiments, such ingredients are identified by prior analysis, e.g., by access to the PDM generator and preparation tool prior to visiting the building to prepare the PDM (thereby giving advanced notice about the kinds of ingredients required).

In certain embodiments of the buildings of the present invention, the devices for preparing the PDM are selected from one or more of the group consisting of stove/oven, refrigerator, knives, cookware, pots/pans, dishes, kitchen devices, and utensils.

Another embodiment of the present invention provides a method for preparation by a host user of a preference differential menu (PDM) for a guest user comprising the steps of:
offering access to a building for preparing a preference differential menu (PDM) structured to comprise:
   a preference differential menu (PDM) generator and preparation tool of the present invention such that a PDM is generated for use (e.g., a tool) by the user in preparing the PDM;
   an ingredient collection for use in preparing the PDM; and
   one or more devices for preparing the PDM (e.g., stove/oven, refrigerator, knives, pots/pans, dishes, or utensils);
offering access to the preference differential menu (PDM) generator and preparation tool;
offering access to the an ingredient collection for use in preparing the PDM; and
offering access to one or more devices for preparing the PDM, such that the host user may generate the PDM and prepare the PDM within the building for the guest users.

In certain embodiments of the methods of preparation of the present invention, the ingredient collection includes any ingredient required to prepare the PDM. In certain embodiments, such ingredients are identified by prior analysis, e.g., by access to the PDM generator and preparation tool prior to visiting the building to prepare the PDM (thereby giving advanced notice about the kinds of ingredients required).

In certain embodiments of the methods of preparation of the present invention, the devices for preparing the PDM are selected from one or more of the group consisting of stove/oven, refrigerator, knives, cookware, pots/pans, dishes, kitchen devices, and utensils.

### V. Design Aspects of the Invention

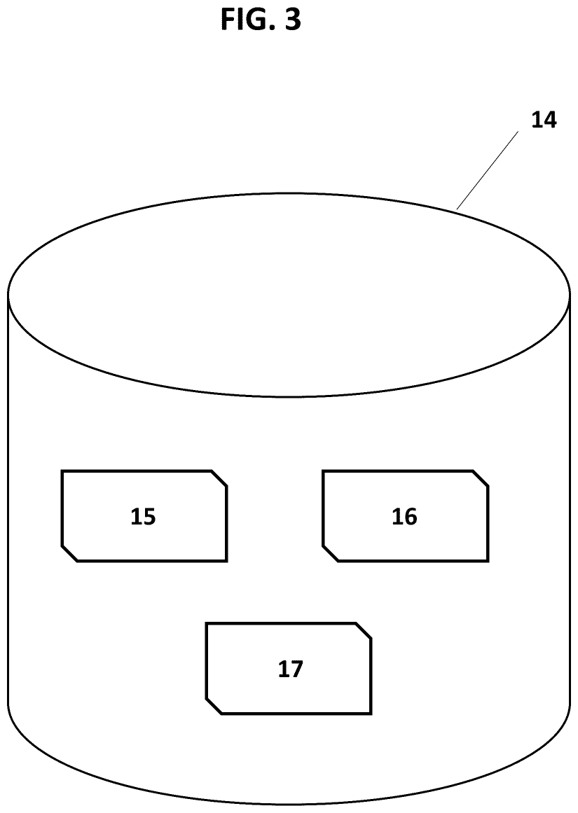

Independent of the utility related to the containers of the present invention, the ornamental appearance of any novel design provided herein is intended to be part of this invention, for example, FIG. 3, which may form an independent or combined ornamental appearance of the building described herein.

Accordingly, one embodiment of the present invention provides an ornamental design for a building of the present invention as shown and described.

### EXEMPLIFICATION

Having thus described the invention in general terms, reference will now be made to exemplary embodiments, and the accompanying drawings of exemplary embodiments, which are not necessarily drawn to scale, and which are not intended to be limiting in any way.

In this respect, it is to be understood that the invention is not limited in its application to the details of construction and to the arrangements of the components set forth in the following description or illustrated in the Figures. The invention is capable of other embodiments and of being practiced and carried out in various ways. Also, it is to be understood that the phraseology and terminology employed herein are for the purpose of description and should not be regarded as limiting.

### Example 1

### Exemplary Embodiment

### Preference Differential Menu (PDM) Generator And Preparation Tool

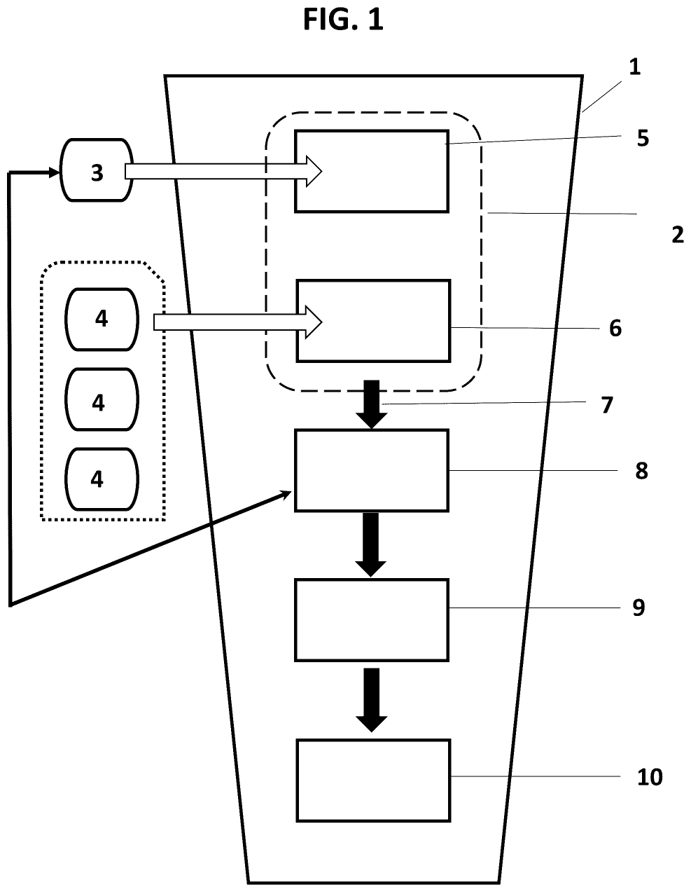

An exemplary embodiment of the preference differential menu (PDM) generator and preparation tool of the present invention is described below and depicted in FIG. 1 as a flow diagram.

The exemplary preference differential menu (PDM) generator and preparation tool 1 comprises a user interface 2 for collecting and aggregating data. The user interface 2 comprises a first machine-readable medium having instructions stored thereon for execution by a processor to perform a method. Host user 3 accesses user interface 2, and enters host preference data into survey 5, which is collected and stored on a second machine-readable medium. Multiple guest users 4 access user interface 2, and enter user preference data into survey 6, which is collected and stored on a third machine-readable medium. The stored host preference data and the stored guest preference data are aggregated 7 using preference differential analytics, defining dish matrix array 8. Dish matrix array 8 is then used to generate preference differential menu (PDM) 9, such that the PDM is generated and is a tool for use by the user in preparing the PDM.

Host user 3, upon viewing dish matrix array 8, elects a unique dish matrix, which is used to generate preference differential menu (PDM) 9. The elected preference differential menu (PDM) 9 is then used to generate a preparation output 10.

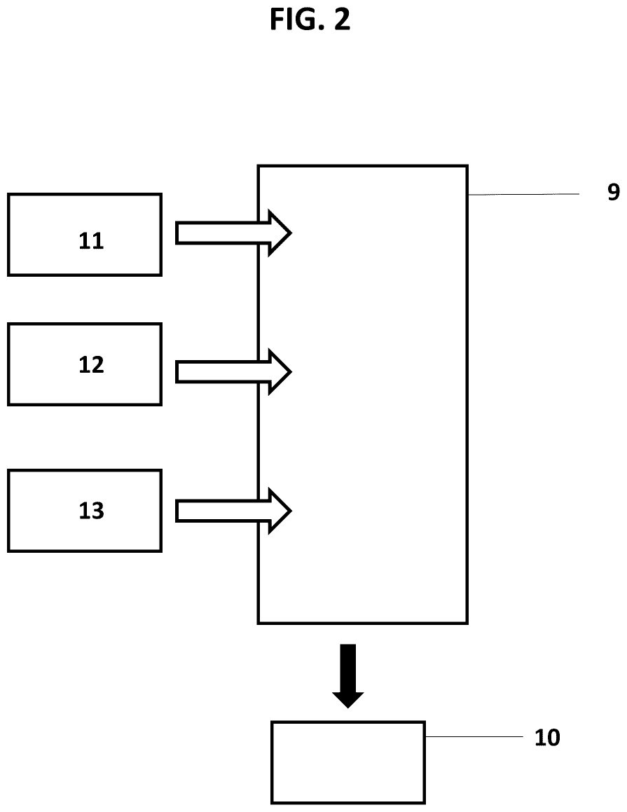

FIG. 2 depicts the flow of information that may modify the elected preference differential menu (PDM) 9 through contributory factors to generate preparation output 10. In particular, the following factors may contribute to preparation output 10:
Quantification of ingredients of the elected unique dish matrix (11);
Quantification of ingredients is optimized, e.g., based on guest users per dish or dishes and servings per user (12); and
Applying a scaling factor based on increases in guest user count (13)

### Example 2

### Exemplary Embodiment

### Building For Preparing Preference Differential Menu (PDM)

FIG. 3 depicts an exemplification of certain building of the present invention that incorporate a preference differential menu (PDM) generator and preparation tool of the present invention. Building 14 for preparing a preference differential menu (PDM) is structured to comprise a preference differential menu (PDM) generator and preparation tool 15 (e.g., as described and shown in Example 1, FIG. 1 and FIG. 2), ingredient collection 16 for use in preparing the PDM, and one or more devices 17 for preparing the PDM, such as, stove/oven, refrigerator, knives, cookware, pots/pans, dishes, kitchen devices, and utensils.

### INCORPORATION BY REFERENCE

The entire contents of all patents, published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents were considered to be within the scope of this invention and are covered by the following claims. Moreover, any numerical or alphabetical ranges provided herein are intended to include both the upper and lower value of those ranges. In addition, any listing or grouping is intended, at least in one embodiment, to represent a shorthand or convenient manner of listing independent embodiments; as such, each member of the list should be considered a separate embodiment.

What is claimed is:

1. A preference differential menu (PDM) generator and preparation tool comprising a user interface for collecting and aggregating data, wherein the user interface comprises a first machine-readable medium having instructions stored thereon for execution by a processor to perform a method comprising the steps of:
accessing the user interface by a host user;
collection and storage of host preference data on a second machine-readable medium;
collection and storage of a guest preference data on a third machine-readable medium;
aggregation of the stored host preference data and the stored guest preference data using preference differential analytics; and
definition of a dish matrix array based on said aggregation from which a preference differential menu (PDM) is generated,
such that the PDM is generated and is a tool for use by the user in preparing the PDM.

2. The preference differential menu (PDM) generator and preparation tool of claim 1, further comprising the step of:
election of a unique dish matrix by host user from the dish matrix array, such that the preference differential menu (PDM) is generated.

3. The preference differential menu (PDM) generator and preparation tool of claim 2, further comprising the step of:
quantification of ingredients of the elected unique dish matrix.

4. The preference differential menu (PDM) generator and preparation tool of claim 3, wherein the quantification of ingredients is optimized.

5. The preference differential menu (PDM) generator and preparation tool of claim 3, further comprising the step of:
applying a scaling factor based on increases in guest user count.

6. The preference differential menu (PDM) generator and preparation tool of claim 3, further comprising the step of:
generating a preparation output.

7. The preference differential menu (PDM) generator and preparation tool of claim 6, wherein the preparation output is selected from one or more of the group consisting of recipes, shopping lists, shopping amounts, kitchen accessories required and preparation instructions.

8. The preference differential menu (PDM) generator and preparation tool of claim 1, wherein the collection of host preference data comprises administration of a first survey.

9. The preference differential menu (PDM) generator and preparation tool of claim 1, wherein the collection of guest preference data comprises administration of a second survey.

10. The preference differential menu (PDM) generator and preparation tool of claim 8, wherein the first survey is the same as the second survey.

11. The preference differential menu (PDM) generator and preparation tool of claim 1, wherein the aggregation of the stored host preference data and the stored guest preference data requires a minimum number of guest preference data.

12. The preference differential menu (PDM) generator and preparation tool of claim 1, wherein the definition of the dish matrix array comprises the step of
identifying dish types.

13. The preference differential menu (PDM) generator and preparation tool of claim 1, wherein the definition of the dish matrix array comprises the step of
determining the number of dishes.

14. The preference differential menu (PDM) generator and preparation tool of claim 1, wherein the dish matrix array offers a variety of types of cuisine.

15. The preference differential menu (PDM) generator and preparation tool of claim 1, wherein the dish matrix array offers a variety of substitutions for ingredients.

16. The preference differential menu (PDM) generator and preparation tool of claim 1, wherein the first machine readable medium, the second machine readable medium, and the third machine readable medium are the same.

17. A building for preparing a preference differential menu (PDM) structured to comprise:
a preference differential menu (PDM) generator and preparation tool of claim 1, such that a PDM is generated and is a tool for use by the user in preparing the PDM;
an ingredient collection for use in preparing the PDM; and
one or more devices for preparing the PDM.

18. The building of claim 17, wherein the devices for preparing the PDM are selected from one or more of the group consisting of stove/oven, refrigerator, knives, cookware, pots/pans, dishes, kitchen devices, and utensils.

19. A method for preparation by a host user of a preference differential menu (PDM) for a guest user comprising the steps of:
offering access to a building for preparing a preference differential menu (PDM) structured to comprise:
a preference differential menu (PDM) generator and preparation tool of claim 1, such that a PDM is generated and is a tool for use by the user in preparing the PDM;
an ingredient collection for use in preparing the PDM; and
one or more devices for preparing the PDM;
offering access to the preference differential menu (PDM) generator and preparation tool;
offering access to the an ingredient collection for use in preparing the PDM; and
offering access to one or more devices for preparing the PDM, such that the host user may generate the PDM and prepare the PDM within the building for the guest users.

20. The method of claim 19, wherein the devices for preparing the PDM are selected from one or more of the group consisting of stove/oven, refrigerator, knives, cookware, pots/pans, dishes, kitchen devices, and utensils.
